(19) United States
(12) Patent Application Publication
(10) Pub. No.: US 2025/0103359 A1
(43) Pub. Date: Mar. 27, 2025

(54) NATIVE INTERACTION LAYER FOR A COLLABORATION PLATFORM

(71) Applicant: Figma, Inc., San Francisco, CA (US)

(72) Inventors: Robert Bye, San Francisco, CA (US); Adam Barrus, San Francisco, CA (US); Nicholas Hiotis, San Francisco, CA (US); Khalil Cader, San Francisco, CA (US); Grayson Lang, San Francisco, CA (US); Kurt Revis, San Francisco, CA (US); Rhett Dickson, San Francisco, CA (US); Joey Wang, San Francisco, CA (US); Chris Wendel, San Francisco, CA (US)

(21) Appl. No.: 18/819,244

(22) Filed: Aug. 29, 2024

Related U.S. Application Data
(60) Provisional application No. 63/540,177, filed on Sep. 25, 2023.

(51) Int. Cl. G06F 9/451; G06F 3/0488; G06F 16/958

(52) U.S. Cl. CPC G06F 9/452; G06F 3/0488; G06F 16/958

(57) ABSTRACT

A computing device can initiate a hybrid collaborative application to present, on the touch-sensitive display device, a user interface enabling user interaction with (i) a native layer providing a user with a set of interactive tools for a collaborative session, and (ii) a browser application layer underlying the native layer, where the browser application layer comprises a collaborative canvas enabling the user and one or more remote collaborators to participate in the collaborative session. The computing devices can receive user inputs via the user interface on the touch-sensitive display, render native content on the touch-sensitive display based on the user inputs via the native layer, and render web-based content on the collaborative canvas based at least in part on collaboration inputs via the browser application layer for the collaborative session with the one or more remote collaborators.

### CROSS-REFERENCE TO RELATED APPLICATION

This application claims the benefit of priority to U.S. Provisional Application No. 63/540,177, filed on Sep. 25, 2023, which is hereby incorporated by reference in its entirety.

### TECHNICAL FIELD

Examples described herein relate to hybrid web-based and native communication layers for providing a collaboration platform.

### BACKGROUND

Software design tools have many forms and applications. In the realm of application user interfaces, for example, software design tools enable designers to blend functional aspects of a program with aesthetics, resulting in a collection of pages that form the user interface of an application.

### BRIEF DESCRIPTION OF THE DRAWINGS

FIG. 1A illustrates a user computing device including a hybrid collaboration application for providing a hybrid native-web user experience for design collaboration, according to one or more examples.

FIG. 1B illustrates a network computing system to implement a browser application layer for hybrid collaboration application, according to one or more examples.

FIG. 2A illustrates an example user interface that includes native features for design collaboration on a collaborative canvas, according to one or more examples.

FIG. 2B illustrates an example user interface provided during a collaborative session comprising multiple collaborators, according to one or more examples.

FIGS. 3 and 4 are flow charts describing processes for implementing a hybrid native-web collaboration application, according to one or more examples.

FIG. 5 is a block diagram illustrating a computer system on which one or more embodiments can be implemented.

FIG. 6 is a block diagram illustrating a user computing device for use with one or more examples described herein.

### DETAILED DESCRIPTION

Examples described herein involve providing a native application layer in real-time communication with a web-based, browser application layer for a collaborative platform. In various examples, a computer system is configured to implement an interactive graphic design system for designers, such as user interface designers (“UI designers”), web designers, web developers, etc. A hybrid collaborative application is described herein that can be initiated on computing devices, such as tablet computers, smartphones, and other touchscreen-based personal computers. The hybrid collaborative application can present a user interface enabling user interaction with a native layer providing a user with a set of interactive tools for a collaborative session with one or more remote collaborators.

In various implementations, the hybrid collaborative application can further provide a browser application layer underlying the native layer. The browser application layer can provide a collaborative canvas enabling the user and the one or more remote collaborators to participate in the collaborative session. Based on user inputs via the user interface, the collaborative application can render native content on the touch-sensitive display based on the user inputs via the native layer. The collaborative application further renders web-based content on the collaborative canvas based on collaboration inputs via the browser application layer for the collaborative session.

In certain examples, the browser application layer presents a collaborative design on the collaborative canvas based on the collaboration inputs provided by the one or more remote collaborators, and the user inputs provided on the touch-sensitive display device. The native content presented on the touch-sensitive display device can include a set of native modals and one or more native toolbars. The set of native modals and the one or more native toolbars can facilitate the user in providing input and updates to the collaborative design. The set of native modals can include comment and reaction components that are rendered natively on the touch-sensitive display device based on the user inputs.

In practice, remote collaborators can interact locally with the native application layer that provides the user with the increased perceived performance of a native application, such that touch responsiveness and user interactivity with the user interface provides the user with increased precision as compared to a web-application. As such, native functionality is included in the hybrid collaborative application to provide content, manipulate content, provide toolbar functions and other native interactive functions, which are integrated with the web-app collaborative canvas by way of real-time communication between the native layer and the browser application layer (or web-app layer).

Certain technical advantages are realized by the hybrid native-web implementations described herein. In particular, the web-app is provided via a browser (e.g., typically on personal computers having a keyboard and mouse setup) in which users interact with the collaborative canvas using a mouse cursor presented on a display screen. As such, interactive inputs are configured for mouse cursor inputs, which are used for rendering web-based content via the web-app. When a touch-sensitive screen is used (e.g., on a tablet computer or smartphone), the cursor input configuration of the web-app can be cumbersome when the user provides touch inputs using one or more fingers or an active stylus device (e.g., an APPLE PENCIL, SURFACE PEN, etc.).

In accordance with examples provided herein, the native layer of the collaborative application can provide adjusted touch targets for touch inputs and/or active stylus inputs. Furthermore, the native layer provides increased responsiveness as compared to the browser-application layer to improve the fine input responses required for application UI and/or website design. As such, the touch targets for the touch inputs and/or active stylus inputs may be adjusted from touch targets configured for mouse cursor inputs. In further examples, the touch inputs provided by the user and translated via the native layer for presentation in the user's computing device can cause web-based content to be propagated to the collaborative canvas presented on a plurality of other computing devices (e.g., the device(s) of one or more collaborators in a collaboration session). The browser application layer can translate data provided to the native layer based on the user's inputs and transmit input data corresponding to the user inputs to a network computing system that causes the web-based content to be rendered on the collaborative canvas, which is presented on a plurality of computing devices that include the computing device of the user and one or more additional computing devices corresponding to the one or more remote collaborators.

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more embodiments described herein can be implemented using programmatic modules, engines, or components. A programmatic module, engine, or component can include a program, a subroutine, a portion of a program, or a software component or a hardware component capable of performing one or more stated tasks or functions. As used herein, a module or component can exist on a hardware component independently of other modules or components. Alternatively, a module or component can be a shared element or process of other modules, programs, or machines.

Some embodiments described herein can generally require the use of computing devices, including processing and memory resources. For example, one or more embodiments described herein may be implemented, in whole or in part, on computing devices such as servers, desktop computers, cellular or smartphones, tablets, wearable electronic devices, laptop computers, printers, digital picture frames, network equipment (e.g., routers) and tablet devices. Memory, processing, and network resources may all be used in connection with the establishment, use, or performance of any embodiment described herein (including with the performance of any method or with the implementation of any system).

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices and/or tablets), and magnetic memory. Computers, terminals, network-enabled devices (e.g., mobile devices, such as cell phones) are all examples of machines and devices that utilize processors, memory, and instructions stored on computer-readable mediums. Additionally, embodiments may be implemented in the form of computer-programs, or a computer-usable carrier medium capable of carrying such a program.

### System Description

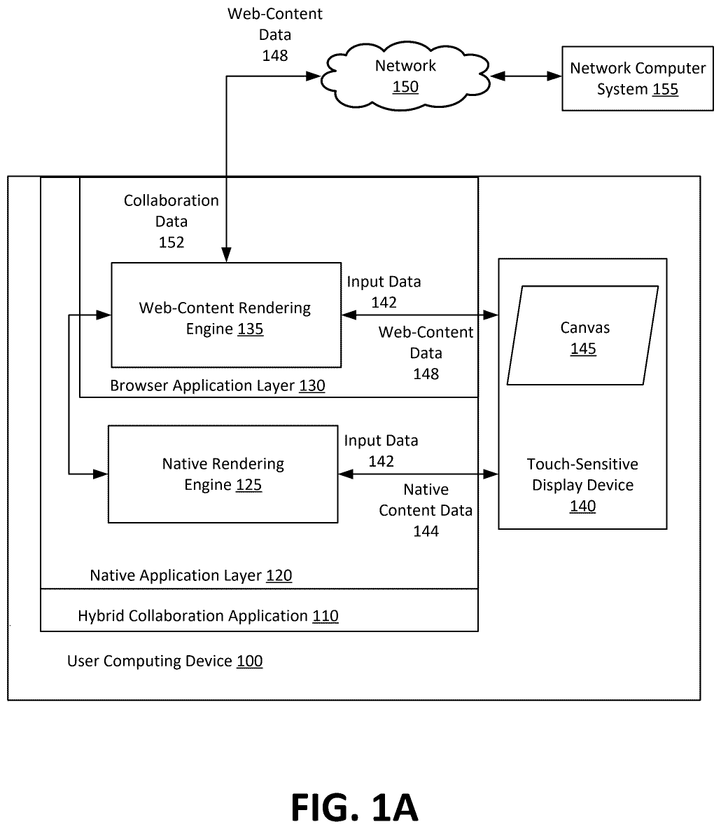

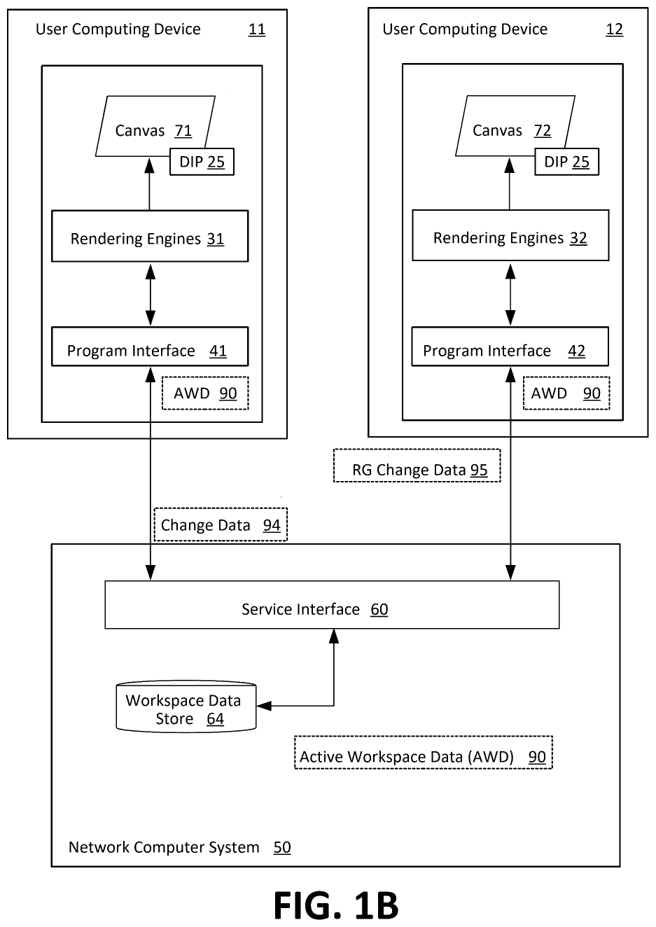

FIG. 1A illustrates a user computing device 100 including a hybrid collaboration application 110 for providing a hybrid native-web user experience for design collaboration, according to one or more examples. The hybrid collaboration application 110 can be implemented in any one of multiple different computing environments. For example, in some variations, the hybrid collaboration application 110 can be implemented as a user-side application that executes on the user computing device 100 to provide functionality as described with various examples. In various examples, hybrid collaboration application 110 can be implemented as a combined native application and web application that execute upon initiation of the hybrid collaboration application 110.

For example, the hybrid collaboration application 110 may be implemented as a native application developed for use on a particular platform, such as but not limited to native ANDROID and/or IOS, etc. Additionally, the hybrid collaboration application 110 can include browser functionality be implemented as a distributed system, such that processes described with various examples execute on both a backend network computer (e.g., server) and on the user computing device 100 through communications over one or more networks 150.

According to examples, the hybrid collaboration application 110 can be implemented on a user computing device 100 to enable a corresponding user to create, view, and/or modify design interfaces using graphical elements. A design interface may include any layout of content and/or interactive elements, such as (but not limited to) a web page. The hybrid collaboration application 110 can be executed as a native application that includes a native application layer 120 and a browser application layer 130. In various examples, the native application layer 120 directly translates input data 142 corresponding to user inputs provided on a touch-sensitive display device 140 of the user computing device 100. In particular, the native application layer 120 can include a native rendering engine 125 that provides native content data 144 to be presented on the touch-sensitive display device 140.

In various examples, the hybrid collaboration application 110 can further include a browser application layer 130 in real-time communication with the native application layer 110. The browser application layer 130 can comprise a web-content rendering engine 135 that renders web-content data 148 on a collaborative canvas 145 presented on the touch-sensitive display device 140. For example, during a collaboration session in which the user of the computing device 100 collaborates with one or more collaborators, the user can interact with a set of native modals, such as toolbars, commenting and reaction features, etc. that are presented on the touch-sensitive display device 140. The native rendering engine 125 can process the input data 142 corresponding to the user inputs and generate native content data 144 as responses to the user inputs for display on the touch-sensitive display device 140. The web-content rendering engine 135 of the browser application layer 130 can further translate the input data 142 directly, or as processed by the native rendering engine 125 to generate web-content data 148 that can be presented on the collaborative canvas 145.

In further implementations, the web-content data 148 can be propagated to computing devices of other collaborators over one or more networks 150. For example, the web-content data 148 can be transmitted to a backend network computer system 155 providing the platform for the collaboration session. The backend network computer system 155 may then propagate the web-content data 148 for presentation on the collaborative canvas presented on the computing devices of the other participants in the collaboration session. Likewise, the inputs of these participants on their computing devices can also be processed by the network computer system 155 and propagated to the collaborative canvas 145 presented on the touch-sensitive display device 140. In particular, the inputs provided by the other collaborators can be processed by the network computer system 155, which generates collaboration data 152 based on the inputs. The web-content rendering engine 135 processes the collaboration data 152 and then generates web-content data 148 to render web-content on the collaborative canvas 145 based on the inputs from the other collaborators.

Accordingly, the user experience in interacting with the collaborative canvas 145 on the touch-sensitive display 140 is provided as a native application experience that is configured for touch inputs using fingers and/or an active stylus device. The local processing by the native rendering engine 125 provides the various benefits of a native user experience, such as an increased frame rate, a significantly shortened and near seamless response time, increased precision for aspects such as drawing and other artistic inputs, and significant reductions in display latency.

Additionally, the web-content rendering engine 135 of the browser application layer 130 facilitates the collaboration aspects of the hybrid collaboration application 110 by propagating the user's inputs to the collaborative canvas 145 presented on the computing devices of the other participants in the collaboration session. The web-content rendering engine 135 of the browser application layer 130 also propagates the inputs provided by the other participants to the collaborative canvas 145 presented on the touch-sensitive display device 140 of the user computing device 100. In certain examples, the browser application layer 130 can comprise an embedded browser in the hybrid collaboration application 110, and can execute scripts, code, and/or other logic (the “programmatic components”) to implement the functionality of the web-content rendering engine 135 described herein.

In certain examples, the browser application layer 130 can be implemented as web code that can include (but is not limited to) HyperText Markup Language (HTML), JAVASCRIPT, Cascading Style Sheets (CSS), other scripts, and/or other embedded code which the hybrid collaboration application 110 receives from a network site. For example, the hybrid collaboration application 110 can execute web code that is embedded within a web page. The web code can also cause the hybrid collaboration application 110 to execute and/or retrieve other scripts and programmatic resources (e.g., libraries) from the network site and/or other local or remote locations. By way of example, the browser application layer 130 of the hybrid collaboration application 110 may include JAVASCRIPT embedded in an HTML resource (e.g., web page structured in accordance with HTML 5.0 or other versions, as provided under standards published by W3C or WHATWG consortiums) that is executed by the browser application layer 130. In some examples, the web-content rendering engine 135 of the browser application layer 130 may utilize graphics processing unit (GPU) accelerated logic, such as provided through WebGL (Web Graphics Library) programs which execute Graphics Library Shader Language (GLSL) programs that execute on GPUs.

In some implementations, the web-content rendering engine 135 can generate the collaborative canvas 145 using programmatic resources that are associated with a browser application (e.g., an HTML 5.0 canvas). As an addition or variation, the web-content rendering engine 135 and/or the native rendering engine 125 can trigger or otherwise cause the collaborative canvas 145 to be generated using programmatic resources and data sets (e.g., canvas parameters) which are retrieved from local (e.g., memory) or remote sources (e.g., from network computer system 155).

The hybrid collaboration application 110 may also retrieve programmatic resources that include an application framework for use with the collaborative canvas 145. The application framework can include data sets that define or configure a set of interactive graphic tools that integrate with the collaborative canvas 145. For example, the interactive graphic tools may enable the user to provide input for creating and/or editing a design interface.

According to some examples, the native application layer 120 can be implemented as a functional layer that is integrated with the collaborative canvas 145 to detect and interpret user input. In one or more embodiments, the native rendering engine 125 of the native application layer 120 can, for example, use a reference of the collaborative canvas 145 to identify screen locations of user inputs (e.g., touch or active stylus inputs). Additionally, the native rendering engine 125 can interpret an input action of the user based on the location of the detected input (e.g., whether the position of the input indicates selection of a tool, an object rendered on the collaborative canvas 145, or region of the canvas 145), the frequency of the detected input in a given time period (e.g., tap and hold), and/or the start and end position of an input or series of inputs (e.g., start and end positions of a drag input), as well as various other input types which the user can specify (e.g., pinch, zoom, scroll, etc.) through one or more input devices. In this manner, the native rendering engine 125 can interpret, for example, a series of inputs as a design tool selection (e.g., shape selection based on location/s of input), as well as inputs to define properties (e.g., dimensions) of a selected shape.

In various examples, the native rendering engine 125 and the web-content rendering engine 135 operate in concert to generate the user interface—which can include a design in progress—presented on the touch-sensitive display, which can comprise native elements layered on the collaborative canvas 145. The user interface can include graphic elements and their respective properties to enable the user to edit the design in progress using one or more input devices (e.g., fingers, passive stylus, active stylus, etc.). As an addition or alternative, the native rendering engine 125 and the web-content rendering engine 135 can generate a blank page for the collaborative canvas 145, and the user can interact with various displayed tools to initiate a design in progress. As rendered, the design in progress can include graphic elements such as a background and/or a set of objects (e.g., shapes, text, images, programmatic elements), as well as properties of the individual graphic elements.

Each property of a graphic element can include a property type and a property value. For an object, the types of properties include shape, dimension (or size), layer, type, color, line thickness, font color, font family, font size, font style, and/or other visual characteristics. Depending on implementation details, the properties reflect attributes of two- or three-dimensional designs. In this way, property values of individual objects can define visual characteristics such as size, color, positioning, layering, and content for elements that are rendered as part of the design in progress.

Individual design elements may also be defined in accordance with a desired run-time behavior. For example, some objects can be defined to have run-time behaviors that are either static or dynamic. The properties of dynamic objects may change in response to predefined run-time events generated by the underlying application that is to incorporate the design in progress. Additionally, some objects may be associated with logic that defines the object as being a trigger for rendering or changing other objects, such as through implementation of a sequence or workflow. Still further, other objects may be associated with logic that provides the design elements to be conditional as to when they are rendered and/or their respective configuration or appearance when rendered. Still further, objects may also be defined to be interactive, where one or more properties of the object may change based on user input during the run-time of the application.

The native rending engine 125 can process input data 142 corresponding to user inputs provided on the touch-sensitive display 140, where the input data 142 indicates (i) an input action type (e.g., shape selection, object selection, sizing input, color selection), (ii) an object or objects that are affected by the input action (e.g., an object being resized), (iii) a desired property that is to be altered by the input action, and/or (iv) a desired value for the property being altered. The native rendering engine 125 can implement changes indicated by the input data 142 to locally update active workspace data presented on the touch-sensitive display device 140. The native rendering engine 125 can update the collaborative canvas 145 to reflect the changes to the affected objects in the design in progress.

### Collaborative Network Platform

FIG. 1B illustrates a network computing system 50 to implement a browser application layer for hybrid collaboration application, according to one or more examples. In an example of FIG. 1B, a collaborative network platform is implemented by the network computer system 50, which communicates with multiple user computing devices 11-12 over one or more networks (e.g., the World Wide Web) to present a shared, collaborative design interface on the user computing devices 11-12. While FIG. 1B illustrates an example in which two users utilize the collaborative network platform, examples as described allow for the network computer system 50 to enable collaboration on design interfaces among users using a larger number of user computing devices. Among other advantages, the collaborative network platform allows users to more concurrently access a design interface, and to conveniently manipulate objects while the network computer system 50 manages synchronization and access issues.

With respect to FIG. 1B, the user computing devices 11-12 can be operated by users that are associated with a common account or accounts associated with a particular design in progress 25. Each user computing device 11-12 presents the design in progress 25 on a collaborative canvas 71-72 presented on each device during respective sessions. As such, each of the user computing devices 11-12 may access a set of active workspace data 90 at the same time using respective program interfaces 41-42 on each of the user computing devices 11-12.

In examples, the service interface 60 can load the active workspace data 91-92 corresponding to the design in progress 25 from a workspace data store 64, and transmit a copy of the active workspace data 90 to each user computing device 11-12 such that the respective rendering engines 31-32 (i.e., the web-content rendering engine 135 of FIG. 1A) render the design in progress 25 corresponding to the active workspace data 90 at the same time, such as during overlapping sessions.

In some examples, the network computer system 50 can continuously synchronize the active workspace data 90 corresponding to the design in progress 25 presented on the user computing devices 11-12. Thus, changes made by users to the design in progress 25 on one user computing device 11 may be reflected on the design in progress 25 rendered on the other user computing device 12 in real-time. By way of example, when a change is made to the design in progress 25 at one user computing device 11, the respective rendering engine 31 (e.g., native rendering engine 125 shown in FIG. 1A) updates the respective canvas 71 locally and transmits change data 94 corresponding to the changes to the service interface 60 of the network computer system 50 (e.g., via web-content rendering engine 135). The service interface 60 processes the change data 94 from the user computing device 11 and uses the change data 94 to make a corresponding change to the active workspace data 90. The service interface 60 can also transmit remotely-generated change data 95 (which in the example provided, corresponds or reflects the change data 94 received from the user computing device 11) to the other user computing device 12 that has loaded the same design in progress 25, causing the corresponding rendering engines 32 to generate the changes to the design in progress 25 accordingly, such as by causing the program interface 42 and rendering engines 32 to update the respective collaborative canvas 72. In this manner, active workspace data 90 is synchronized across any number of user computing devices 11-12 that are using the respective workspace data.

In certain examples, to facilitate the synchronization of the active workspace data 90 at the user computing devices 11-12 and the network computer system 50, the network computer system 50 may implement a stream connector to merge data streams between the network computer system 50 and user computing devices 11-12 that have loaded the same design in progress 25. For example, the stream connector may merge a first data stream between user computing device 11 and the network computer system 50 with a second data stream between user computing device 12 and the network computer system 50. In some implementations, the stream connector can be implemented to enable each computing device 11-12 to make changes to the server-side active workspace data 90 without added data replication that may otherwise be required to process the streams from each user computing device 11-12 separately.

In accordance with example provided herein, the rendering engines 31-32 of each user computing device 11-12 can include a native content rendering engine and a web-content rendering engine, where the native content rendering engine performs content updates to the design in progress 25 locally and provides the user with the interactive precision and frame rate of a native application. As further provided herein, the web-content rendering engine coordinates the updates and change data 94-95 with the network computing system 50, which manages the active workspace data 90 that corresponds to the design in progress 25. As such, changes to the design in progress 25 made on either computing device 11-12 are propagated to the other computing device 11-12. In examples provided, the network computer system 50 can link such changes to any number of computing devices during a collaboration session participated by any number of collaborators. Using the hybrid native and web implementations described, the computing devices can comprise personal computers having a mouse-keyboard setup in which the user utilizes key and cursor functionality to interact with other collaborators, as well as touchscreen-based personal computers having touch input functionality that enables users to interact with the design in progress 25 using fingers or touch tools, as described herein.

### Example User Interfaces

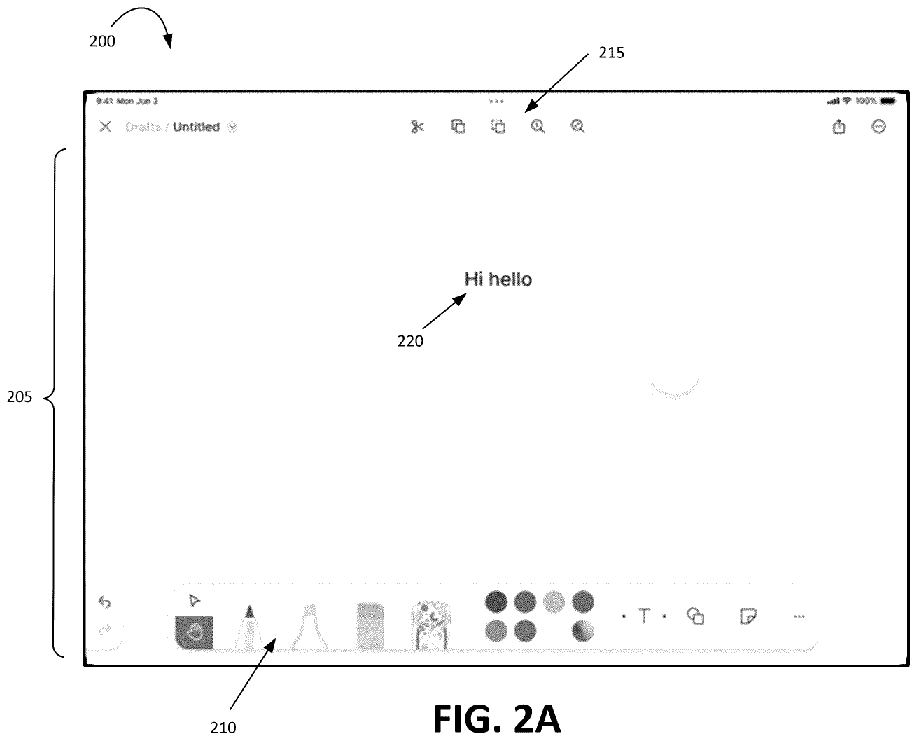

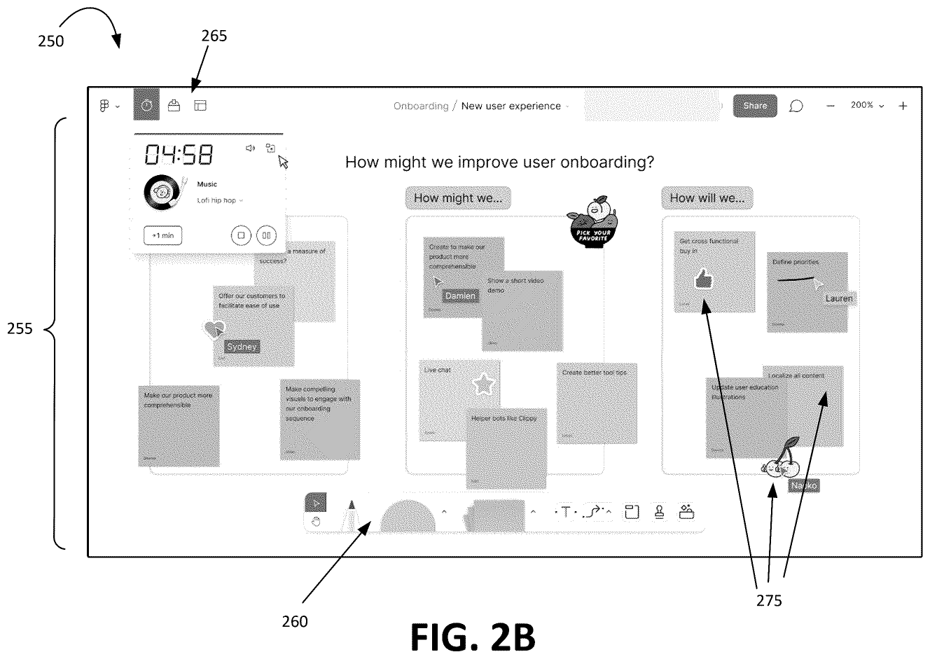

FIG. 2A illustrates an example user interface 200 that includes native features for design collaboration on a collaborative canvas 205, according to one or more examples. In various implementations, the user interface 200 can be presented on a user computing device 100, as shown and described in connection with FIG. 1A, or user computing devices 11-12 of any number of collaborators participating in a collaborative session, as shown and described with respect to FIG. 1B. Furthermore, the user interfaces 200, 250 shown in FIGS. 2A and 2B can be presented on a touch-sensitive computing device, such as a tablet computer, smartphone device, or other touchscreen-based personal computer.

In certain examples, the user interface 200 can present a collaborative canvas 205 that underlies a set of native features, such as a creative toolbar 210 for adding design elements, posting text or comments 220 providing reactions (e.g., emojis) to contributions from other participants. The set of native features can include additional features, such as a header toolbar 215, sidebars, and the like. As provided herein, the set of native features can be generated by a native rendering engine 125 that directly processes user input from a user of the computing device.

The native rendering engine 125 can process user input provided by the user locally, and generate interactive responses to those inputs locally on the underlying collaborative canvas 205. As provided herein, the web-content rendering engine 135 can propagate the user's inputs to the computing devices of the other collaborators via the backend network computer system 50, which coordinates and manages the collaborative network platform. As further provided herein, the web-content rendering engine 135 communicates with the network computer system 50 to propagate design change data provided by the other collaborators to the collaborative canvas 205 presented on the computing device of the user.

FIG. 2B illustrates an example user interface 250 provided during a collaborative session comprising multiple collaborators, according to one or more examples. In various examples, the user interface 250 can include a collaborative canvas 255 that is presented on the computing devices of each of the collaborators. As shown in FIG. 2B, the collaborative canvas 255 presents content elements 275 provided by each of the collaborators for designing a particular user interface (e.g., for a website or application). The content elements 275 provided by the other collaborators, such as comments, suggestions, notes, reactions, design elements, and the like can be generated by the web-content rendering engine 135 for display on the collaborative canvas 255.

In further implementations, the set of native features, such as the creative toolbar 260, header toolbar 265, and other native modals can be generated by the native rendering engine 125. As such, any interactive inputs provided by the user through interaction with the native features can also be processed and/or translated by the native rendering engine 125. As such, the content rendered on the user interface 250 can be generated by both the web-content rendering engine 135 and the native rendering engine 125 in concert. As described herein, the native content and contributions provided by the user are presented with increased precision and frame rate as compared to a single web-application, with touch targets configured for touch inputs, such as finger gestures and stylus interactions.

As provided herein, the user interfaces 200, 250 shown in FIGS. 2A and 2B can include the underlying collaborative canvas 205, 250 that presents collaboration content elements provided by each of the collaborators, which can include the local user's contributions. These elements are generated by the web-content rendering engine 135, which can communicate with the backend network computer system 50 to propagate these collaboration content elements to each computing device of the collaborators. On the local device, native elements and interaction are processed by the native rendering engine 125, and can further communicate with the web-content rendering engine 135 to propagate the user's contributions to the computing devices of the other collaborators.

### Methodology

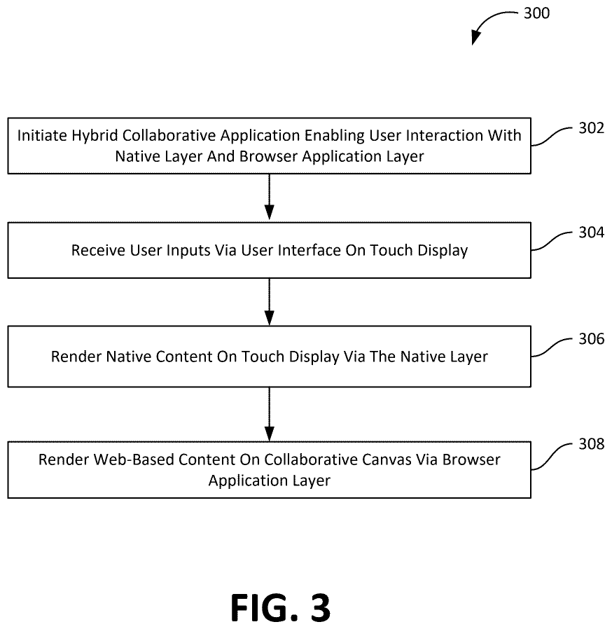

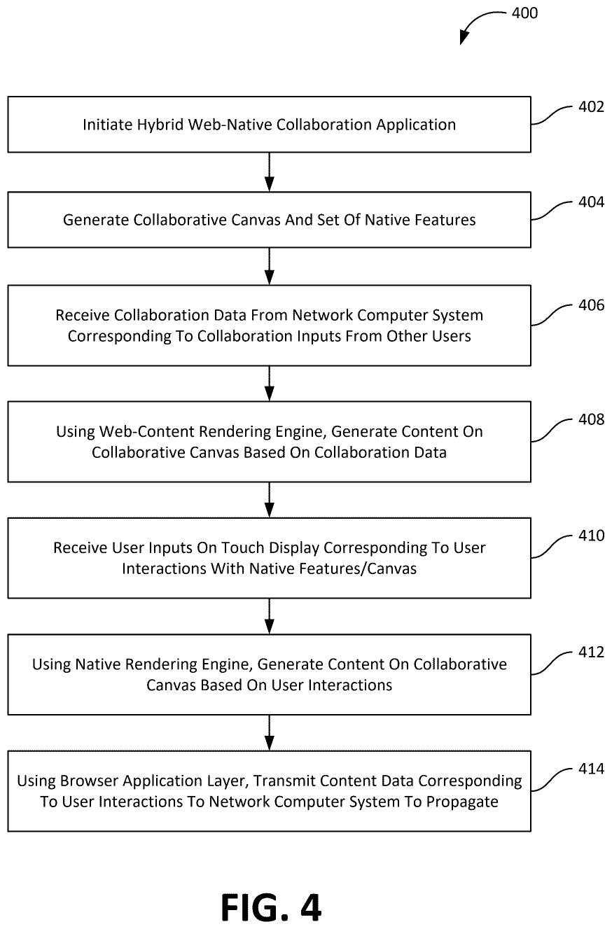

FIGS. 3 and 4 are flow charts 300, 400 describing processes for implementing a hybrid native-web collaboration application 110, according to one or more examples. In the below description of FIGS. 3 and 4, reference may be made to reference characters representing various features as shown and described with respect to FIGS. 1A, 1B, 2A, and 2B. Furthermore, the processes described with respect to FIGS. 3 and 4 may be performed by an example user computing device 100 executing a hybrid collaboration application 110 that includes a native application layer 120 comprising a native rendering engine 125 and a browser application layer 130 comprising a web-content rendering engine 135. Still further, while the processes shown in FIGS. 3 and 4 are shown in a particular order, any step may be performed prior to, in conjunction with, or subsequent to any other step in the flow charts 300, 400 of FIGS. 3 and 4.

Referring to the flow chart 300 of FIG. 3, at block 302, the user computing device 100 can initiate a hybrid collaborative application 110 to present a user interface enabling user interaction with (i) a native application layer 120 providing a user with a set of interactive tools for a collaborative session, and (ii) a browser application layer 130 underlying the native application layer 120. In various examples, the browser application layer 130 can comprise a collaborative canvas 145 enabling the user and one or more remote collaborators to participate in the collaborative session.

At block 304, the user computing device 100 can receive user inputs via the user interface on the touch-sensitive display 140. The user inputs can correspond to the user interacting with any native elements rendered on the user interface and/or the collaborative canvas 145. As provided herein, these native elements can comprise native modals, creative toolbars comprising design tool features, sidebar elements, commenting and reaction features, and the like. At block 306, the user computing device 100 can render native content on the touch-sensitive display 140 via the native application layer 120. At block 308, the user computing device 100 can further render web-based content on the collaborative canvas 145 based at least in part on collaboration inputs (e.g., provided by the user or other collaborators) via the browser application layer 130 for the collaborative session with the one or more remote collaborators.

The flow chart 400 of FIG. 4 describes a more detailed process of implementing a hybrid native-web collaboration application 110, according to one or more examples. Referring to FIG. 4, at block 402, the user computing device 100 can initiate a hybrid web-native collaboration application 110. At block 404, the user computing device can generate a user interface comprising a collaborative canvas 145 and a set of native features, as described herein. As provided herein, the user computing device 100 can further communicate with a backend network computer system 50 that provides collaboration data based on input provided by one or more remote collaborators during a collaboration session with the user.

At block 406, the user computing device 100 can receive collaboration data from the network computer system 50 that correspond to collaboration inputs provided by other users during the collaboration session. These inputs can correspond to changes made to a design in progress 25, or comments, reactions, etc. in a strategic session in which the collaborators coordinate a strategy for a design in progress 25 (such as shown in FIG. 2B). At block 408, the user computing device 100 can generate content on the collaborative canvas 145 based on the collaboration data using the web-content rendering engine 135. As such, the collaboration data is propagated to each computing device of each collaborator by the network computer system 50 that manages the network collaboration platform.

At block 410, the user computing device 100 can further receive user inputs on the touch-sensitive display 140 that correspond to user interactions with the set of native features, modals, toolbars, and/or the collaborative canvas 145. At block 412, the user computing device 100 can generate content on the collaborative canvas 145 using the native rendering engine 125 based on the user interactions. As provided herein, this content can correspond to changes made to a design in progress 25, comments, reactions, replies to comments, emojis, and the like. As further provided herein, the user interactions can comprise touch inputs or active stylus inputs performed by the user on the touch-sensitive display 140. At block 414, the user computing device 100 can transmit content data corresponding to the user interactions to the network computer system 50 to propagate the user's inputs to the computing devices of the other collaborators in the collaboration session.

### Network Computer System

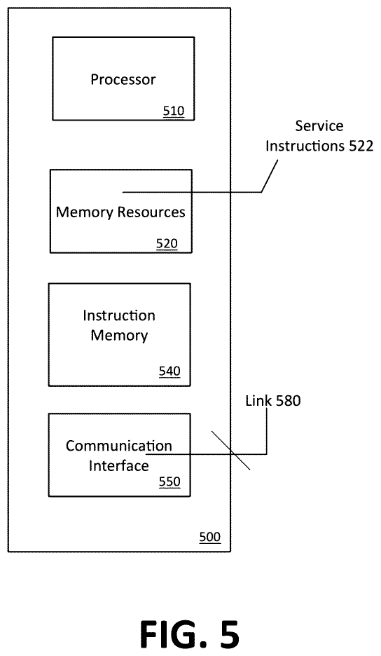

FIG. 5 illustrates a computer system on which one or more embodiments can be implemented. A computer system 500 can be implemented on, for example, a server or combination of servers. For example, the computer system 500 may be implemented as the network computer system 155, 50 of FIGS. 1A and 1B.

In one implementation, the computer system 500 includes processing resources 510, memory resources 520 (e.g., read-only memory (ROM) or random-access memory (RAM)), one or more instruction memory resources 540, and a communication interface 550. The computer system 500 includes at least one processor 510 for processing information stored with the memory resources 520, such as provided by a random-access memory (RAM) or other dynamic storage device, for storing information and instructions which are executable by the processor 510. The memory resources 520 may also be used to store temporary variables or other intermediate information during execution of instructions to be executed by the processor 510.

The communication interface 550 enables the computer system 500 to communicate with one or more user computing devices, over one or more networks (e.g., cellular network) through use of the network link 580 (wireless or a wire). Using the network link 580, the computer system 500 can communicate with one or more computing devices, specialized devices and modules, and/or one or more servers.

In examples, the processor 510 may execute service instructions 522, stored with the memory resources 520, in order to enable the network computing system to implement the collaborative platform and operate as the network computer system 155, 50 in examples such as described with FIG. 1A and FIG. 1B.

The computer system 500 may also include additional memory resources (“instruction memory 540”) for storing executable instruction sets which are embedded with web pages and other web resources, to enable user computing devices to implement functionality such as described throughout the present disclosure.

As such, examples described herein are related to the use of the computer system 500 for implementing the techniques described herein. According to an aspect, techniques are performed by the computer system 500 in response to the processor 510 executing one or more sequences of one or more instructions contained in the memory 520. Such instructions may be read into the memory 520 from another machine-readable medium. Execution of the sequences of instructions contained in the memory 520 causes the processor 510 to perform the process steps described herein. In alternative implementations, hard-wired circuitry may be used in place of or in combination with software instructions to implement examples described herein. Thus, the examples described are not limited to any specific combination of hardware circuitry and software.

### User Computing Device

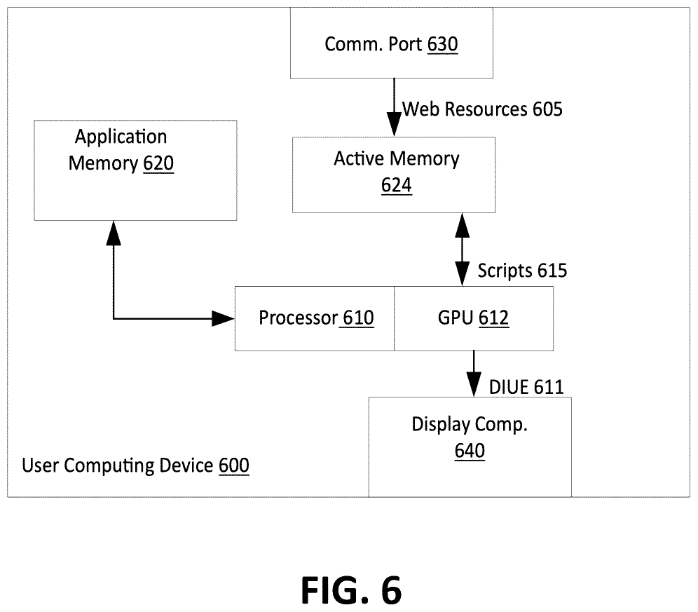

FIG. 6 illustrates a user computing device for use with one or more examples, as described. In examples, a user computing device 600 can correspond to, for example, the user computing device 100 as shown and described with respect to FIG. 1A, and can comprise a smartphone, tablet computer, AR or VR headset, or other touchscreen-based personal computer having graphics processing capabilities that are suitable for enabling renderings of design interfaces and graphic design work.

In examples, the computing device 600 includes a central or main processor 610, a graphics processing unit (GPU) 612, memory resources 620, and one or more communication ports 630. The computing device 600 can use the main processor 610 and the memory resources 620 to store and launch a hybrid web-native collaboration application. In certain examples, a user can operate the application to access a network site of the network collaboration platform, using the communication port 630, where one or more web pages or other web resources 605 for the network collaboration platform can be downloaded. In certain examples, the web resources 605 can be stored in the active memory 624 (cache).

As described by various examples, the processor 610 can detect and execute scripts and other logic which are embedded in the web resources 605 in order to implement the collaborative canvas. In further examples, execution of the hybrid web-native collaboration application stored in application memory 620 can cause a native layer to perform local operations, in accordance with the embodiments described throughout the present disclosure. In some of the examples, some of the scripts 615 which are embedded with the web resources 605 can include GPU accelerated logic that is executed directly by the GPU 612.

The main processor 610 and the GPU can combine to render a design in progress on a display component 640 (e.g., touch-sensitive display device). The rendered design interface can include web content from the web aspect of the hybrid application, as well as design interface content and functional elements generated by scripts and other logic embedded with the web resources 605. Furthermore, the touch inputs on the display component 640 can be processed locally by the native aspects of the hybrid application to present native content on the display component 640, in accordance with example described herein.

### CONCLUSION

Although examples are described in detail herein with reference to the accompanying drawings, it is to be understood that the concepts are not limited to those precise examples. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude having rights to such combinations.

What is claimed is:

1. A computing device comprising:
a touch-sensitive display device;
one or more processors; and
a memory storing instructions that, when executed by the one or more processors, cause the computing device to:
initiate a hybrid collaborative application to present, on the touch-sensitive display device, a user interface enabling user interaction with (i) a native layer providing a user with a set of interactive tools for a collaborative session, and (ii) a browser application layer underlying the native layer, the browser application layer comprising a collaborative canvas enabling the user and one or more remote collaborators to participate in the collaborative session;
receive user inputs via the user interface on the touch-sensitive display device;
render native content on the touch-sensitive display device based on the user inputs via the native layer; and
render web-based content on the collaborative canvas based at least in part on collaboration inputs via the browser application layer for the collaborative session with the one or more remote collaborators.

2. The computing device of claim 1, wherein the browser application layer presents a collaborative design on the collaborative canvas based on (i) the collaboration inputs provided by the one or more remote collaborators, and (ii) the user inputs provided on the touch-sensitive display device.

3. The computing device of claim 2, wherein the native content presented on the touch-sensitive display device includes a set of native modals and at least one native toolbar.

4. The computing device of claim 3, wherein the set of native modals and the at least one native toolbar facilitate the user in providing input and updates to the collaborative design.

5. The computing device of claim 4, wherein the set of native modals include comment and reaction components that are rendered natively on the touch-sensitive display device based on the user inputs.

6. The computing device of claim 4, wherein the user inputs comprise as least one of touch inputs or stylus inputs, and wherein the executed instructions further cause the computing device to:
using the native layer, adjust touch targets configured for the at least one of the touch inputs or the stylus inputs.

7. The computing device of claim 6, wherein the touch targets for the at least one of the touch inputs or the stylus inputs are adjusted from touch targets for mouse cursor inputs used for rendering web-based content.

8. The computing device of claim 1, wherein the executed instructions further cause the computing device to:
transmit, over one or more networks, input data corresponding to the user inputs to a network computing system that causes the web-based content to be rendered on the collaborative canvas.

9. The computing device of claim 8, wherein the collaborative canvas is presented on a second computing device, and wherein the executed instructions further cause the computing device to:
transmit, over one or more networks, change data to the second computing device to cause the second computing device to propagate the web-based content and the native content to the collaborative canvas presented on a display of the second computing device.

10. A non-transitory computer readable medium storing instructions that, when executed by one or more processors of a computing device, cause the computing device to:
initiate a hybrid collaborative application to present, on a touch-sensitive display device of the computing device, a user interface enabling user interaction with (i) a native layer providing a user with a set of interactive tools for a collaborative session, and (ii) a browser application layer underlying the native layer, the browser application layer comprising a collaborative canvas enabling the user and one or more remote collaborators to participate in the collaborative session;
receive user inputs via the user interface on the touch-sensitive display device;
render native content on the touch-sensitive display device based on the user inputs via the native layer; and
render web-based content on the collaborative canvas based at least in part on collaboration inputs via the browser application layer for the collaborative session with the one or more remote collaborators.

11. The computing device of claim 10, wherein the browser application layer presents a collaborative design on the collaborative canvas based on (i) the collaboration inputs provided by the one or more remote collaborators, and (ii) the user inputs provided on the touch-sensitive display device.

12. The computing device of claim 11, wherein the native content presented on the touch-sensitive display device includes a set of native modals and at least one native toolbar.

13. The computing device of claim 12, wherein the set of native modals and the at least one native toolbar facilitate the user in providing input and updates to the collaborative design.

14. The computing device of claim 13, wherein the set of native modals include comment and reaction components that are rendered natively on the touch-sensitive display device based on the user inputs.

15. The computing device of claim 13, wherein the user inputs comprise as least one of touch inputs or stylus inputs, and wherein the executed instructions further cause the computing device to:
using the native layer, adjust touch targets configured for the at least one of the touch inputs or the stylus inputs.

16. The computing device of claim 15, wherein the touch targets for the at least one of the touch inputs or the stylus inputs are adjusted from touch targets for mouse cursor inputs used for rendering web-based content.

17. The computing device of claim 10, wherein the executed instructions further cause the computing device to:
transmit, over one or more networks, input data corresponding to the user inputs to a network computing system that causes the web-based content to be rendered on the collaborative canvas.

18. The computing device of claim 17, wherein the collaborative canvas is presented on a second computing device, and wherein the executed instructions further cause the computing device to:
transmit, over one or more networks, change data to the second computing device to cause the second computing device to propagate the web-based content and the native content to the collaborative canvas presented on a display of the second computing device.

19. A computer-implemented method of facilitating collaboration sessions, the method being performed by one or more processors and comprising:
initiating a hybrid collaborative application to present, on a touch-sensitive display device of the computing device, a user interface enabling user interaction with (i) a native layer providing a user with a set of interactive tools for a collaborative session, and (ii) a browser application layer underlying the native layer, the browser application layer comprising a collaborative canvas enabling the user and one or more remote collaborators to participate in the collaborative session;
receiving user inputs via the user interface on the touch-sensitive display device;
rendering native content on the touch-sensitive display device based on the user inputs via the native layer; and
rendering web-based content on the collaborative canvas based at least in part on collaboration inputs via the browser application layer for the collaborative session with the one or more remote collaborators.

20. The method of claim 19, wherein the browser application layer presents a collaborative design on the collaborative canvas based on (i) the collaboration inputs provided by the one or more remote collaborators, and (ii) the user inputs provided on the touch-sensitive display device.
